(19) United States
(12) Patent Application Publication
(10) Pub. No.: US 2005/0176439 A1
(43) Pub. Date: Aug. 11, 2005

(54) Wireless base transceiver station unit

(76) Inventor: Masayuki Sasaki, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/047,768

(22) Filed: Feb. 2, 2005

(30) Foreign Application Priority Data
Feb. 6, 2004 (JP) 2004-030093

(51) Int. Cl. H04Q 7/20

(52) U.S. Cl. 455/450

(57) ABSTRACT

A wireless base transceiver station unit that performs the wireless communication of communications signals makes effective use of the channel resources of a plurality of wireless base transceiver station units. In a wireless base transceiver station unit (the BTS unit 1 system) provided with signal processing means 34-37 that process communications signals, a means of allocating communications signal processing to another unit 32 allocates communications signal processing means 54-57 provided in another wireless base transceiver station unit (the BTS unit 2 system) as the communications signal processing means that processes communications signals from the one unit, and the means of communicating communication signals among other units 33, 38 and 43 communicate communications signals from the one unit to which communications signal processing means 54-57 provided in the other wireless base transceiver station unit are allocated by the means of allocating communications signal processing to another unit 32 with this other wireless base transceiver station unit.

### FIELD OF THE INVENTION

This invention relates to the wireless base transceiver station of a mobile communications system or the like, and particularly to a wireless base transceiver station that is able to make effective usage of the channel resources of a plurality of wireless base transceiver stations.

### DESCRIPTION OF THE PRIOR ART

In wireless communications systems, the main service content is changing from voice to data, and new types of wireless base transceiver stations have been developed in order to handle this change. Moreover, with conventional wireless base transceiver stations, the channel resources allocated to that base transceiver station can be used only in a closed manner within the wireless base transceiver station in question, so it is necessary to install sufficient wireless base transceiver stations in anticipation of the maximum traffic within each service area. This causes increased initial facilities investment expenses for the telecommunications carrier and also increased system operation expenses.

FIG. 9 shows an example of the configuration of a Universal Terrestrial Radio Access Network (UTRAN).

Specifically, it shows Radio Network Controllers (RNC) 71 and 72 as defined by the 3^{rd} Generation Partnership Project (3GPP), Base Transceiver Stations (BTS) 73-76 as defined by 3GPP, Iub interfaces 77-80 between the RNC and BTS units as defined by 3GPP and an Iur interface 81 between the two RNC units as defined by 3GPP, along with the service areas R11-R14 formed by the BTS units 73-76. Each of the BTS units 73-76 consists of a MDE (Modulation Equipment) unit and a RF (Radio Frequency) unit, where the MDE unit and RF unit may be installed adjacent to or at a distance from each other.

FIG. 10 shows an embodiment of an MDE unit 91 used in the BTS units 73-76.

The MDE unit 91 in this embodiment consists of: an Iub interface functional block (Iub I/F) 101 that terminates the Iub physical layer, a BTS control functional block (BTS CNT) 102 loaded with NBAP/ALCAP and other application software, an Asynchronous Transfer Mode (ATM) switch functional block (ATM SW) 103 that performs switching of signals at the Iub point in accordance with predetermined relationships between the ATM identifiers and functional blocks within the BTS, baseband (BB) signal processing functional blocks (BB1-BB4) 104-107 loaded with channel codec and quadrature modulation/demodulation and spreading/dispreading functions and the like, a sector switch functional block (Sector SW) 108 that achieves flexible allocation and inter-sector maximum ratio synthesis between the signal processing functional blocks 104-107 and optical conversion functional blocks 109-112, and optical conversion functional blocks (OPT1-OPT4) 109-112 that perform frequency conversion from a signal in the spread-modulated state to a signal in a stipulated intermediate frequency (IF) band and then perform optical conversion (conversion from the IF band signal to an optical signal) and the inverse conversion (conversion from the optical signal to the IF band signal).

In addition, the Iub interface functional block 101 is connected to an Iub (interface at the point Iub) 92 that adopts ATM transfer.

In addition, each of the optical conversion functional blocks 109-112 is connected to one of the optical fibers 93a-93d that tie the MDE unit 91 to the RF unit 121.

Note that in this embodiment, each of the optical conversion functional blocks 109-112 is connected to one of the wireless functional blocks for cell 1 through cell 4, respectively. In addition, in this embodiment, the number of cells (4) corresponding to the number of optical conversion functional blocks 109-112 is merely an example; this is not a limitation.

In addition, in this embodiment, the number of signal processing functional blocks 104-107 (4) is unrelated to the number of cells. In addition, in this embodiment, the number of signal processing functional blocks 104-107 (4) is merely an example; this is not a limitation.

FIG. 11 shows an example of the configuration of a RF unit 121 used in the BTS units 73-76.

The RF unit 121 in this example comprises: an optical conversion functional block (OPT) 131 that performs optical conversion (conversion from the IF band signal to an optical signal) on a signal in the spread-modulated state and the inverse conversion (conversion from the optical signal to the IF band signal), a wireless functional block (TRX) 132 that performs frequency conversion on the frequencies of single-frequency or multi-frequency signals between the intermediate frequency (IF) and a stipulated wireless frequency, an amplifier (AMP) functional block (MCPA) 133 that amplifies single-frequency or multi-frequency signals to a stipulated output level, a low noise amplifier (LNA) functional block 134 that incorporates a low noise amplifier, a duplexer functional block (DUP) 135 consisting of a multiplexer and filter, and antennas 122 and 123 with a Rx diversity structure.

In addition, the optical conversion functional block 131 is connected to an optical fiber (e.g., one of the optical fibers 93a-93d shown in FIG. 10).

In addition, in this example, two antennas 122 and 123 are provided, where the one antenna 122 is used for transmission (Tx) and first reception (Rx0) and the other antenna 123 is used for second reception (Rx1).

The actual amounts of traffic in the service areas of the various wireless base transceiver stations vary depending on the time of day and the circumstances of each service area (e.g., industrial areas or residential areas). However, with the UTRAN system shown in FIGS. 9-11, the wireless base transceiver stations are disposed in a dispersed manner and the channel resources of each wireless base transceiver station can only be used in a closed manner within each individual wireless base transceiver station.

Here, as one example of this situation, FIG. 12 shows one RNC unit 141 and three BTS units 142-144 connected to this RNC unit 141. As described above, the BTS units 142-144 are disposed in a dispersed manner, thus forming the individual service areas R21-R23, and the BTS units 142-144 use the channel resources allocated within the BTS units 142-144.

Because of this, the telecommunications carrier must provide sufficient numbers of base transceiver stations (BTS units 142-144) in anticipation of the maximum traffic in the individual service areas R21-R23.

Here, FIG. 13 shows one example of the numbers of resources required, with one example of daytime traffic and one example of nighttime traffic. As illustrated in the table, one may take the total number of resources (23) and subtract from this the total traffic (19) which is the greater of the daytime and nighttime traffic to find the number of resources (4) that require unnecessary initial investment and operating expense costs.

In this manner, in the system shown in FIG. 12, the initial investment and other costs become large, and there are also problems in that the system operation expenses cannot be reduced since the availability of the individual wireless base transceiver stations cannot be optimized.

Note that as background art, studies have been made on allocating unused resources within a single wireless base transceiver station (see Patent References 1 and 2, for example).

As an example, studies were made where, in a base transceiver station for mobile telecommunications, optical switches are inserted between base transceiver station amplifiers installed at a distance via optical fiber and transceivers within the base transceiver station modems, and by changing the position of the switch depending on the traffic in each cell, it is possible to change the connections between base transceiver station amplifiers and transceivers, therefore making advantageous use of the transceivers of base transceiver stations depending on fluctuations in traffic (see Patent Reference 1, for example).

As another example, studies were made where, in a wireless base transceiver station provided with a plurality of baseband processing cards, each of the baseband processing cards notify a supervisory controller of the resource usage state, and resources are selected to allocate channels autonomously based on directions from the supervisory controller. In addition, a resource redistribution process wherein the used resources and unused resources within the card are reordered is performed autonomously, thereby permitting resource allocation to be performed quickly when adding channels or the like (see Patent Reference 2, for example).

Patent Reference 1: Publication of unexamined Japanese patent application (Kokai) No. JP-A-6-153256

Patent Reference 1: Kokai No. JP-A-2003-87854

As described above, with a UTRAN system such as that shown in FIGS. 9-12 for example, the wireless base transceiver stations are disposed in a dispersed manner and the channel resources of each wireless base transceiver station can only be used in a closed manner within each individual wireless base transceiver station, so this prior art was still inadequate to make effective use of channel resources, and additional development was required.

The present invention came about in order to solve these conventional problems and has as its object to provide a wireless base transceiver station that allows the channel resources of a plurality of wireless base transceiver stations to be used effectively.

### SUMMARY OF THE INVENTION

In order to achieve these objects, a wireless base transceiver station unit according to the present invention (referred to herein as “wireless base transceiver station unit A”) is provided with communications signal processing means that processes communications signals, whereby the following process is performed at the time of performing wireless communication of communications signals.

Specifically, the means of allocating communications signal processing to another unit allocates communications signal processing means provided on another wireless base transceiver station (here, wireless base transceiver station unit B) as the communications signal processing means that processes communications signals from one unit (wireless base transceiver station unit A), and means of communicating communications signals among other units communicates communications signals from the one unit A to which a communications signal processing means provided on the other wireless base transceiver station unit B is allocated by the means of allocating communications signal processing to another unit.

In addition, the wireless base transceiver station unit (the aforementioned other wireless base transceiver station unit B) comprises means of communicating communications signals among other units that communicates communications signals from the other wireless base transceiver station unit A to which a communications signal processing means provided on the one unit B is allocated by the means of allocating communications signal processing to another unit of the other wireless base transceiver station unit (wireless base transceiver station unit A), with the other wireless base transceiver station unit A.

Accordingly, communications signals communicated by the one wireless base transceiver station unit A can be processed by the communications signal processing means of the other wireless base transceiver station B, and thus the channel resources of a plurality of wireless base transceiver station units A and B, for example, can be used effectively.

Note that if a wireless base transceiver station unit having both the functions of the wireless base transceiver station unit A and the functions of the wireless base transceiver station unit B is implemented, then the channel resources can be utilized between both A and B, so this is preferable.

Here, various signals can be used as the communications signals; for example, downlink communications signals subject to transmission to mobile stations or the like and uplink communications signals received from mobile stations or the like can be used.

In addition, various types of processing can be used as the processing of communications signals by the communications signal processing means; for example, baseband processing and the like can be used.

In addition, various numbers can be used as the number of communications signal processing means provided in a single wireless base transceiver station unit; for example, this may be one means or a plurality of means.

In addition, as the communications signal processing means that processes communications signals from the one unit, various modes may be used as the mode of allocating communications signal processing means provided in the one unit or the communications signal processing means provided in the other wireless base transceiver station unit; for example, a mode wherein, if the communications signal processing capacity of the communications signal processing means provided on the one unit is full or inadequate even if not full, then the communications signal processing means provided on the other wireless base transceiver station unit is allocated, may be used.

With the wireless base transceiver station unit A according to the present invention, the following processing may be performed as one example of the configuration.

Specifically, the means of allocating communications signal processing to another unit allocates communications signal processing means that has excess communications signal processing capacity provided on the other wireless base transceiver station B as the communications signal processing means that processes communications signals from the one unit A. In addition, regarding the communications signals from the one unit A to which a communications signal processing means provided on the other wireless base transceiver station unit B is allocated by the means of allocating communications signal processing to another unit, the means of communicating communications signals among other units transmits said communications signals before processing by the communications signal processing means (of the one unit A or the other wireless base transceiver station unit B) to said other wireless base transceiver station unit B, and receives from said other wireless base transceiver station unit B said communications signal after processing by the communications signal processing means (of said wireless base transceiver station unit B).

In addition, regarding the communications signals from the other wireless base transceiver station unit A to which a communications signal processing means provided on the one unit B is allocated by the means of allocating communications signal processing to another unit of the other wireless base transceiver station unit (the wireless base transceiver station unit A), the means of communicating communications signals among other units of the wireless base transceiver station unit (the wireless base transceiver station unit B) receives said communications signals before processing by the communications signal processing means (of the one unit A or the other wireless base transceiver station unit B) from said other wireless base transceiver station unit A, and transmits to said other wireless base transceiver station unit A said communications signal after processing by the communications signal processing means (of the one unit B).

Accordingly, communications signals communicated by one wireless base transceiver station unit A can be processed by means of a communications signal processing means that has excess communications signal processing capacity provided on the other wireless base transceiver station unit B, so unused channel resources can be effectively utilized in a plurality of wireless base transceiver station units A and B.

Here, the respective communications signal processing means may have the maximum communications signal processing capacity, for example.

In addition, the number of channel resources that can be used in processing may be used as the communications signal processing capacity of the communications signal processing means.

Here follows additional examples of the configuration of the wireless base transceiver station unit according to the present invention.

As one example of the configuration, the wireless base transceiver station unit is such that downlink communications signals subject to wireless transmission to mobile stations or the like are transmitted wirelessly after being processed by downlink communications signal processing means provided on the one unit or the other wireless base transceiver station unit.

As one example of the configuration, the wireless base transceiver station unit is such that uplink communications signals received wirelessly from a mobile station or the like are transmitted to the other unit (e.g., the other wireless base transceiver station unit or units other than the wireless base transceiver station unit) after being processed by uplink communications signal processing means provided on the one unit or the other wireless base transceiver station unit.

Here, the downlink communications signal processing means and uplink communications signal processing means may be provided separately or as a single unit.

As one example of the configuration, the wireless base transceiver station unit may comprise: other unit communications signal processing excess capacity detection means that detects excess communications signal processing capacity in a communications signal processing means which is provided in another wireless base transceiver station unit.

Here, as the excess communications signal processing capacity situation of the communications signal processing means, for example, the situation of unused channel resources may be used, or specifically the presence of unused channel resources or the number of unused channel resources may be used.

As one example of the configuration, the other unit communications signal processing excess capacity detection means may comprise: other unit communications signal processing excess capacity inquiry means that makes inquires to other wireless base transceiver station units about the excess communications signal processing capacity in a communications signal processing means provided in said other wireless base transceiver station unit, and other unit communications signal processing excess capacity response reception means that receives responses from the other wireless base transceiver station units to inquiries made by the excess capacity inquiry means, thus detecting the excess communications signal-processing capacity situation of the communications signal processing means provided in said other wireless base transceiver station unit based on said response.

Here, the inquiry may be performed by transmitting a signal used for inquiry to the other wireless base transceiver station unit.

As one example of the configuration, the wireless base transceiver station unit may comprise: one unit communications signal processing excess capacity response transmission means that, in response to an inquiry from another wireless base transceiver station unit, transmits a response about the excess communications signal processing capacity the communications signal processing means provided on the one unit to said other wireless base transceiver station unit.

As another example of the configuration, communications signal processing excess capacity detection means that detects excess communications signal processing capacity in a communications signal processing means which is provided in a wireless base transceiver station unit is provided externally to the wireless base transceiver station unit is provided. Moreover, the other unit communications signal processing excess capacity detection means of the wireless base transceiver station unit receives from the excess capacity detection means notice of the results of detection of the excess communications signal processing capacity situation of the communications signal processing means provided on other wireless base transceiver station units, and based on this notice, detects the excess communications signal processing capacity situation of the communications signal processing means provided on other wireless base transceiver station units.

As one example of the configuration, the means of communicating communications signals among other units uses switching to communicate with other wireless base transceiver station units those communications signals from the one unit to which a communications signal processing means provided on another wireless base transceiver station unit is allocated by the means of allocating communications signal processing to another unit.

Here, switching using ATM or other identifiers or the like may be used as the means of switching.

In addition, one of an ATM switch, MDE switch or packet switch, or a combination of two or more of these may be used as the switching means.

As one example of the configuration, the wireless base transceiver station unit may comprise: switching means that perform switching provided on both the stage before and the stage after the communications signal processing means, respectively. The one wireless base transceiver station unit and the other wireless base transceiver station unit communicate communications signals between mutually corresponding switching means.

As one example of the configuration, the wireless base transceiver station unit may comprise: an MDE unit provided with communications signal processing means and switching means, and a RF unit provided with wireless communications functions, which are connected to constitute a unit.

Here, the MDE unit and RF unit may be connected by optical fiber, for example.

As one example of the configuration, the means of communicating communications signals among other units communicates communications signals from the one unit to which a communications signal processing means provided on another wireless base transceiver station unit is allocated by the means of allocating communications signal processing to another unit, between the MDE unit of the one unit and the MDE unit of the other wireless base transceiver station unit.

Here, the MDE unit of the one unit may be connected to the MDE unit of the other wireless base transceiver station unit by a coax cable, for example.

In addition, the MDE unit of the one unit and the MDE unit of the other wireless base transceiver station unit may be installed at nearby places, or at a place deemed to be a single location. As a specific example, they may be installed at as close of distance that the exchange of communications signals is possible. In addition, as a specific example, the RNC and MDE units may be installed at nearby places, or at a place deemed to be a single location.

In addition, a wireless base transceiver station system consisting of a plurality of wireless base transceiver station units may be implemented.

In addition, the wireless base transceiver station unit may be applied to various systems such as cellular phone systems or Personal Handy phone Systems (PHS) or other mobile communications systems.

As described above, with the wireless base transceiver station unit according to the present invention, communications signal processing means provided in another wireless base transceiver station unit may be allocated as the communications signal processing means that processes communications signals from the one unit, and thus communications signals from this one unit can be communicated with the other wireless base transceiver station unit, so the channel resources can be utilized effectively among a plurality of wireless base transceiver station units, for example.

### BRIEF EXPLANATION OF THE DRAWINGS

FIG. 1 is a drawing that shows an example of the constitution of a UTRAN system according to an embodiment of the present invention.

FIG. 2 is a drawing that shows an example of the constitution of a MDE unit.

FIG. 3 is a drawing used to describe an example of the operations performed by the MDE unit.

FIG. 4 is a drawing used to describe an example of the operations performed by the ATM switch functional block.

FIG. 5 is a drawing that shows an example of the allocation of ATM identifiers at the Iub point.

FIG. 6 is a drawing that shows an example of the allocation of ATM identifiers within the MDE unit.

FIG. 7 is a drawing used to describe an example of the operations performed by the MDE sector switch functional block.

FIG. 8 is a drawing used to describe an example of the operations performed by the MDE sector switch functional block.

FIG. 9 is a drawing that shows an example of the constitution of an UTRAN system.

FIG. 10 is a drawing that shows an example of the constitution of an MDE unit used in the BTS.

FIG. 11 is a drawing that shows an example of the constitution of an RF unit used in the BTS.

FIG. 12 is a table that shows an example of comparison of traffic and number of required resources for the BTS.

FIG. 13 is a drawing that shows an example of traffics and numbers of resources required on three BTS.

### DESCRIPTION OF THE PREFERRED EMBODIMENTS

Here follows a description of embodiments of the present invention made with reference to drawings.

Note that this embodiment illustrates the case of applying the present invention to a base transceiver station (BTS) that adopts the Wide band-Code Division Multiple Access (W-CDMA) protocol, but the present invention may be applied to various types of equipment and is not limited by the wireless access link protocol.

FIG. 1 shows an example of the constitution of a UTRAN system according to an embodiment of the present invention.

Specifically, it shows two radio network controllers (RNC) 1 and 2 as defined by 3GPP, MDE units 3-6 for four wireless base transceiver stations as defined by 3GPP, RF units 7-10 for these four wireless base transceiver stations, four Iub interfaces (Iub points) 11-14 (interface points) between the RNC and BTS units (in this embodiment, MDE units 3-6) as defined by 3GPP, four optical fibers 15-18 that are connected between the MDE units 3-6 and RF units 7-10 and that permit long-distance communication between these units, an Iur interface (Iur point) 19 (interface point) between the two RNC units as defined by 3GPP, two inter-MDE interfaces 20 and 21 which serve as the interfaces (interface points) between the two MDE units provided in order to flexibly utilize the BTS resources. In addition, the service areas R1-R4 formed by the BTS units consisting of the MDE units 3-6 and RF units 7-10 are also shown.

Here, the MDE units 3-6 have all of the functions of the wireless base transceiver stations (BTS units) excluding the wireless functional blocks. In addition, the RF units 7-10 extract only the wireless functional blocks among all of the functions of the wireless base transceiver stations (BTS units). To wit, in this embodiment, each of the wireless base transceiver stations is constituted by connecting one of the MDE units 3-6 and one of the RF units 7-10 by the optical fibers 15-18. Note that in this embodiment, the MDE units 3-6 and RF units 7-10 are installed at a distance from each other, but a configuration in which these units are installed adjacent to each other or a configuration in which these units are installed near each other may also be used.

In this embodiment, the RNC units 1 and 2 and MDE units 3-6 are disposed together in a centralized location, with the inter-MDE interfaces 20 and 21 each provided between two MDE units (in this embodiment, between MDE units 3 and 4 and between MDE units 5 and 6), while the RF units 7-10 are installed on the side of the service areas R1-R4. With this constitution, in this embodiment, the resources of the various BTS units are centralized in one location, so it is possibly to use all of the centralized resources to flexibly handle increases or decreases in traffic in the service areas R1-R4.

Here follows a schematic description of one example of the operations performed by the UTRAN system shown in FIG. 1.

The RNC units 1 and 2 perform control of the wireless network, communication with the MDE units 3-6 via Iub interfaces 11-14 and communication with the other RNC units 2 and 1 via Iur interface 19. As a specific example, RNC unit 1 performs communication with MDE unit 3 via Iub interface 11 and communication with MDE unit 4 via Iub interface 12, and communication with RNC unit 2 via Iur interface 19, while the other RNC unit 2 does the same.

In addition, the MDE units 3-6 perform the stipulated signal processing, communication with the RNC units 1 and 2 via Iub interfaces 11-14 and communication with the RF units 7-10 via optical fibers 15-18. As a specific example, MDE unit 3 performs communication with RNC unit 1 via Iub interface 11 and communication with RF unit via optical fiber 15, while the other MDE units 4-6 do the same.

In addition, RF units 7-10 are provided with antennas and perform processes required for wireless communications, communication with MDE units 3-6 via optical fibers 15-18, and also wireless communication of signals using the antenna. As a specific example, RF unit 7 performs communication with MDE unit 3 via optical fiber 15, and also wireless communication of signals with mobile stations within the service area R1 using the antenna. In addition, the other RF units 8-10 do the same.

In addition, the MDE units 3-6 send the signals for mobile stations (downlink signals) to the RF units 7-10 and receive signals from mobile stations (uplink signals) from the RF units 7-10. In addition, upon receiving signals for mobile stations (downlink signals) from the MDE units 3-6, the RF units 7-10 wirelessly transmit the signals from the antenna and receive signals from the mobile stations with the antenna and transmit them to the MDE units 3-6.

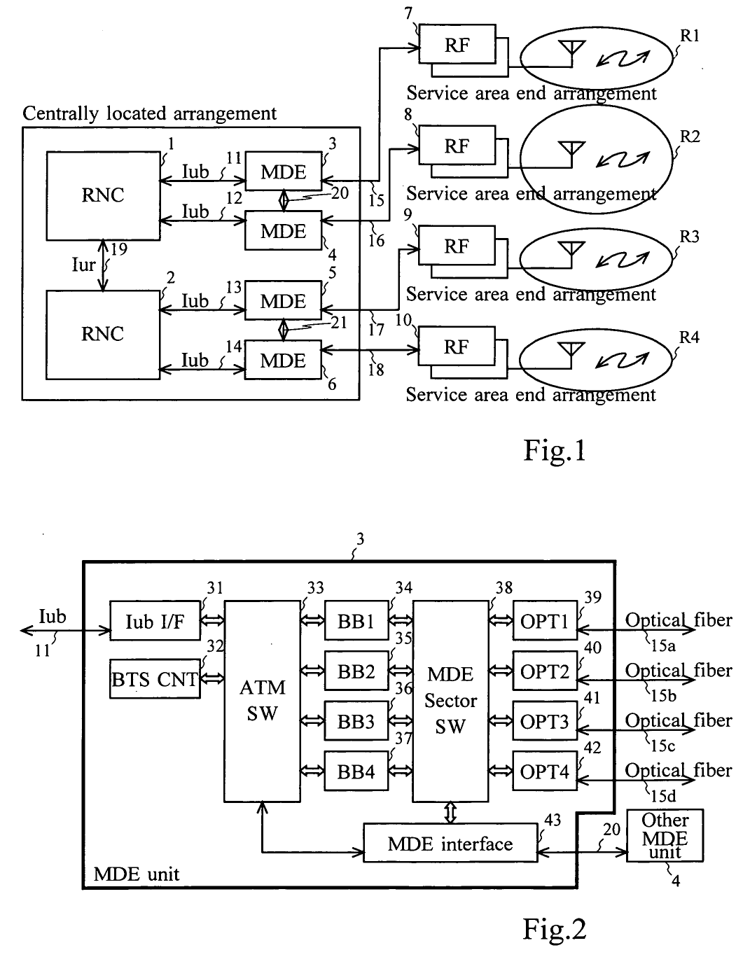

FIG. 2 shows an example of the constitution of the MDE unit in this embodiment. Note that the other MDE units 4-6 have the same constitution.

The MDE unit 3 in this embodiment consists of: an Iub interface functional block (Iub I/F) 31 that terminates the Iub physical layer, a BTS control functional block (BTS CNT) 32 loaded with NBAP/ALCAP and other application software, an ATM switch functional block (ATM SW) 33 that performs switching of signals at the Iub point in accordance with predetermined relationships between the ATM identifiers and functional blocks within the BTS, four signal processing functional blocks (BB1-BB4) 34-37 loaded with channel codec and quadrature modulation/demodulation and spreading/dispreading functions and the like, a MDE sector switch functional block (MDE Sector SW) 38 that achieves flexible allocation of the number of channels within the same MDE unit and within the cells within other MDE units and inter-sector maximum ratio synthesis, and four optical conversion functional blocks (OPT1-OPT4) 39-42 that perform frequency conversion from a signal in the spread-modulated state to a signal in a stipulated intermediate frequency (IF) band and then perform optical conversion (conversion from the IF band signal to an optical signal) and the inverse conversion (conversion from the optical signal to the IF band signal), and an MDE interface functional block 43 that performs multiplexing/demultiplexing in order to unify signals related to the ATM switch functional block 33 and MDE sector switch functional block 38 and transmits and receives signals to and from the other MDE unit (different MDE unit) 4.

In addition, the Iub interface functional block 31 is connected to an Iub (interface at the point Iub) 11 that adopts ATM transfer.

In addition, each of the optical conversion functional blocks 39-42 is connected to one of the optical fibers 15a-15d that tie the MDE unit 3 to the RF unit 7. Here, in this embodiment, the RF unit 7 consists of four RF unit blocks and the optical fiber 15 consists of four optical fibers 15a-15d, and one MDE unit 3 is connected to each of the four respective RF unit blocks by one of the optical fibers 15a-15d. The same applies to the other RF units 8-10 and the other optical fibers 16-18.

In addition, the MDE interface functional block 43 is connected to a coax cable (inter-MDE interface) 20 connected between the MDE unit 3 and MDE unit 4.

Note that in this embodiment, the number of signal processing functional blocks 34-37 (4) and the number of optical conversion functional blocks 39-42 (4) are unrelated to the number of cells. In addition, in this embodiment, the number of signal processing functional blocks 34-37 (4) is merely an example; this is not a limitation.

Here follows a schematic description of one example of the operations performed by the MDE unit 3 shown in FIG. 2.

By means of the Iub interface functional block 31, signals received from Iub interface 11 (downlink signals) may be transmitted via, for example, ATM switch functional block 33, one of the signal processing functional blocks 34-37, the MDE sector switch functional block 38 and one of the optical conversion functional blocks 39-42 to one of the optical fibers 15a-15d corresponding to that one of the optical conversion functional blocks 39-42.

In addition, by means of the optical conversion functional blocks 39-42, signals received from the corresponding optical fibers 15a-15d may be transmitted via, for example, MDE sector switch functional block 38, one of the signal processing functional blocks 34-37, ATM switch functional block 33 and the Iub interface functional block 31 to the Iub interface 11.

In addition, with the MDE unit 3 of this embodiment, downlink signals are transmitted via the ATM switch functional block 33 and MDE interface functional block 43 to the other MDE unit 4, and upon their receipt by the MDE interface functional block 43 from this other MDE unit 4 and transmission to the MDE sector switch functional block 38, it is possible to process these downlink signals using the signal processing functions of this other MDE unit 4.

In addition, with the MDE unit 3 of this embodiment, uplink signals are transmitted via the MDE sector switch functional block 38 and MDE interface functional block 43 to the other MDE unit 4, and upon their receipt by the MDE interface functional block 43 from this other MDE unit 4 and transmission to the ATM switch functional block 33, it is possible to process these uplink signals using the signal processing functions of this other MDE unit 4.

In addition, the BTS control functional block 32 communicates with the ATM switch functional block 33 and performs various types of control.

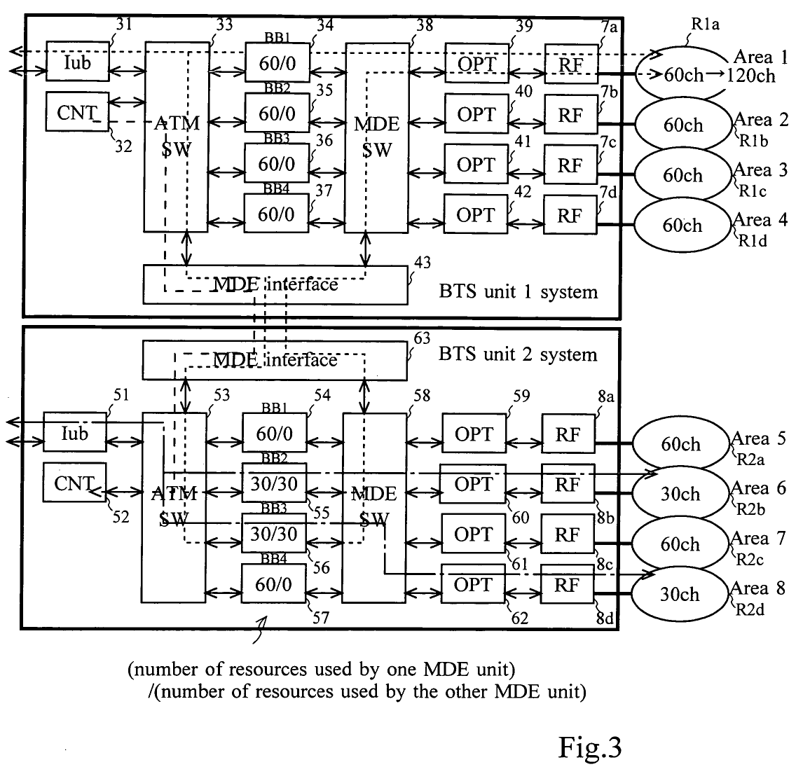

With reference to FIG. 3, an example of an operation wherein the signal processing functions of the other MDE unit 4 are utilized by the MDE unit 3 according to this embodiment is illustrated. Note that the same goes for the case in which the signal processing functions of MDE unit 3 are utilized by the MDE unit 4, or the case in which this type of utilization occurs between MDE unit 5 and MDE unit 6.

In addition, in this embodiment, the description is done using two MDE units 3 and 4, but the number of inter-MDE interfaces provided in one MDE unit is not particularly limited, as various numbers may be used.

FIG. 3 shows the BTS unit 1 system as consisting of: various processing blocks 31-42 that make up the MDE unit 3, four RF units 7a-7d connected to the optical conversion functional blocks 39-42 and the service areas R1a-R1d formed by the RF units 7a-7d.

In addition, FIG. 3 shows the BTS unit 2 system as consisting of: various processing blocks 51-62 that make up the MDE unit 4, four RF units 8a-8d connected to the optical conversion functional blocks 59-62 and the service areas R2a-R2d formed by the RF units 8a-8d. Here, the processing blocks 51-62 that make up the MDE unit 4 are the same as the processing blocks 31-42 that make up the MDE unit 3.

In FIG. 3, the number of channel resources that can be processed by the signal processing functional blocks 34-37 and 54-57 is assumed to be 60 channels (ch), and the case in which traffic increases in service area R1a formed by RF unit 7a is shown.

In addition, FIG. 3 shows the information {(number of resources used by one MDE unit)/(number of resources used by the other MDE unit)} for the signal processing functional blocks 34-37 and 54-57. For example, “60/0” is shown for signal processing functional block 34 of the BTS unit 1 system, so the number of resources used by one MDE unit 3 is 60 channels and the number of resources used by the other MDE unit 4 is 0 channels. In addition, for example, “30/30” is shown for signal processing functional block 55 of the BTS unit 2 system, so the number of resources used by one MDE unit 4 is 30 channels and the number of resources used by the other MDE unit 4 is 30 channels.

Specifically, in the BTS unit 1 system, in order to handle the increase in traffic in service area R1a, the BTS control functional block 32 of the BTS unit 1 system first makes a query to the BTS control functional block 52 of the BTS unit 2 system about the presence of unused resources in the BTS unit 2 system via the ATM switch functional block 33 of the BTS unit 1 system, the MDE interface functional block 43 of the BTS unit 1 system, the MDE interface functional block 63 of the BTS unit 2 system and the ATM switch functional block 53 of the BTS unit 2 system. Here, assuming that each of the two signal processing functional blocks 55 and 56 of the BTS unit 2 system has 30 channels worth of unused resources, the BTS control functional block 52 of the BTS unit 2 system notifies the BTS control functional block 32 of the BTS unit 1 system that 30 channels worth of usable resources are present in each of signal processing functional block 55 and signal processing functional block 56.

Upon doing so, the BTS control functional block 32 of the BTS unit 1 system sends the BTS control functional block 52 of the BTS unit 2 a request to shift 30 channels worth of resources from each of the two signal processing functional blocks 55 and 56, and in response the BTS control functional block 52 of the BTS unit 2 system receives this request and allocates the channel resources of signal processing functional block 55 and signal processing functional block 56 (30 channels of each) so that they can be used by the BTS unit 1 system.

Next, upon receiving notice from the BTS control functional block 52 of the BTS unit 2 system has received this request and confirming that the request was accepted, the BTS control functional block 32 of the BTS unit 1 system thereafter enables the ATM identifiers of the signal processing functional block 55 and signal processing functional block 56 of the BTS unit 2 system in the ATM switch functional block 33 of the BTS unit 1 system enables the path between the Iub interface functional block 31 of the BTS unit 1 system and the signal processing functional block 55 of the BTS unit 2 system, and also enables the path between the Iub interface functional block 31 of the BTS unit 1 system and the signal processing functional block 56 of the BTS unit 2 system. Note that prior to performing this control, for example, any invalid cells are discarded within the ATM switch functional block 33.

In addition, when the BTS control functional block 32 of the BTS unit 1 system is to process signals in the downlink direction (from the BTS to the mobile station (MS)), in order to enable the path from the signal processing functional blocks 55 and 56 of the BTS unit 2 system via the MDE sector switch functional block 58 of the BTS unit 2 system and the MDE sector switch functional block 38 of the BTS unit 1 system toward the optical conversion functional block 39 of the BTS unit 1 system, the MDE identifiers of the signal processing functional block 55 and signal processing functional block 56 of the BTS unit 2 system are enabled with respect to the MDE sector switch functional block 38 of the BTS unit 1 system, and thereby, the downlink signals coming from the signal processing functional block 55 and signal processing functional block 56 of the BTS unit 2 system are multiplexed within the MDE sector switch functional block 38 which is the stage previous to the optical conversion functional block 39 of the BTS unit 1 system. Note that prior to performing this control, for example, invalid signals within the MDE sector switch functional block 38 are zero-inserted within the MDE sector switch functional block 38.

In addition, when the BTS control functional block 32 of the BTS unit 1 system is to process signals in the uplink direction (from the mobile station to the BTS), in order to enable the path from the optical conversion functional block 39 of the BTS unit 1 system via the MDE sector switch functional block 38 of the BTS unit 1 system and the MDE sector switch functional block 58 of the BTS unit 2 system toward the signal processing functional blocks 55 and 56 of the BTS unit 2 system, the MDE identifiers of the optical conversion functional block 39 of the BTS unit 1 system are enabled with respect to the MDE sector switch functional block 58 of the BTS unit 2 system, and thereby, the uplink signals from the optical conversion functional block 39 of the BTS unit 1 system reach the signal processing functional block 55 and signal processing functional block 56 of the BTS unit 2 system. Note that prior to performing this control, for example, invalid signals within the MDE sector switch functional block 58 are zero-inserted within the MDE sector switch functional block 58.

In this manner, 30 channels worth of downlink signals or 30 channels worth of uplink signals are processed using a path via Iub interface functional block 31 of the BTS unit 1 system, ATM switch functional block 33 of the BTS unit 1 system, MDE interface functional block 43 of the BTS unit 1 system, MDE interface functional block 63 of the BTS unit 2 system, ATM switch functional block 53 of the BTS unit 2 system, signal processing functional block 55 of the BTS unit 2 system, MDE sector switch functional block 58 of the BTS unit 2 system, MDE interface functional block 63 of the BTS unit 2 system, MDE interface functional block 43 of the BTS unit 1 system, MDE sector switch functional block 38 of the BTS unit 1 system and optical conversion functional block 39 of the BTS unit 1 system.

Similarly, a path passing through signal processing functional block 56 of the BTS unit 2 system instead of signal processing functional block 55 of the BTS unit 2 system, as described above, is used to process 30 channels worth of downlink signals or 30 channels worth of uplink signals.

Thereby, 120 channels worth of resources can be used in the service area R1a corresponding to optical conversion functional block 39 of the BTS unit 1 system. Note that service area R2b corresponding to signal processing functional block 55 of the BTS unit 2 system and service area R2d corresponding to signal processing functional block 56 of the BTS unit 2 system are able to use 30 channels worth of resources.

Note that in this embodiment, if the resources within one wireless base transceiver station (BTS unit 1) become insufficient, the BTS control functional block 32 of its MDE unit 3 makes inquiries to the ATM switch functional block 53 of the other wireless base transceiver station (BTS unit 2) regarding the situation of unused resources (e.g., their presence or number, etc.) and receives responses, thereby determining the situation of the unused resources of this other wireless base transceiver station (BTS unit 2). In another example of configuration, a monitoring unit that monitors the situation of unused resources in all wireless base transceiver stations is provided, and the wireless base transceiver stations are notified of the situation of unused resources determined by this monitoring unit, so this configuration can also be used.

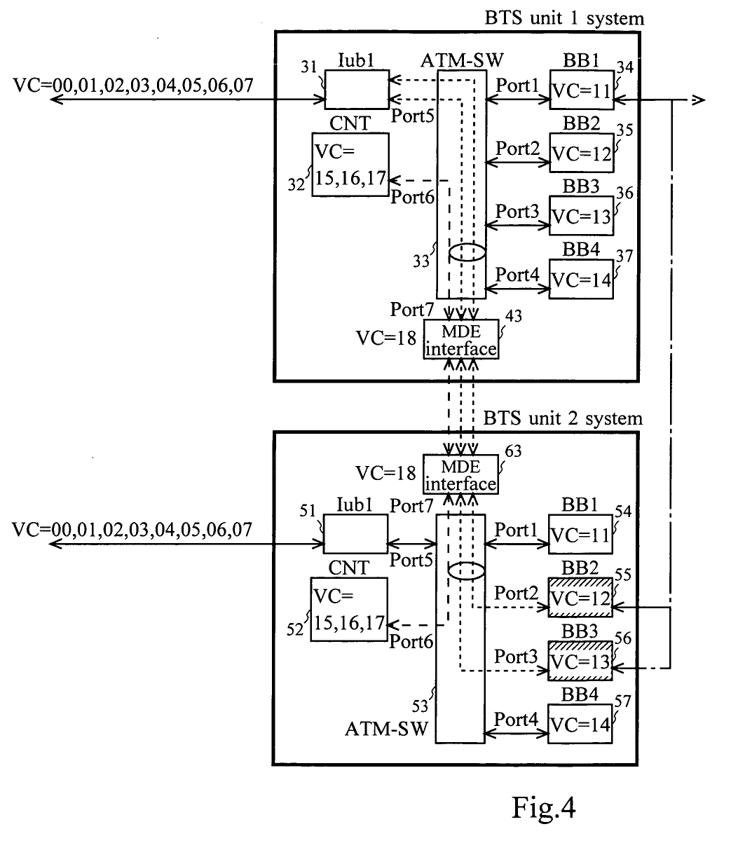

With reference to FIGS. 4-6, an example of the operations performed by the ATM switch functional blocks 33 and 53 of this embodiment is illustrated.

FIG. 4 illustrates the ATM switch functional block 33 of the BTS unit 1 system and the various processing blocks 31, 32, 34-37 and 43 connected thereto, along with the ATM switch functional block 53 of the BTS unit 2 system and the various processing blocks 51, 52, 54-57 and 63 connected thereto.

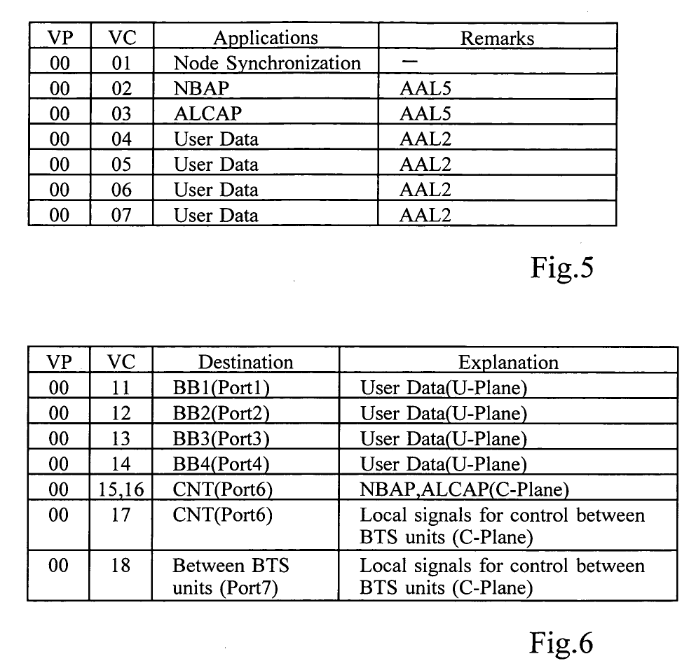

FIG. 5 shows an example of the allocation of ATM identifiers at the Iub interfaces (Iub points) 31 and 51. Specifically, it shows an example of the virtual path (VP) identifiers in ATM, the virtual channel (VC) identifiers in ATM and the correspondence with their applications, along with remarks (in this embodiment, the ATM adaptation layer (AAL)).

FIG. 6 shows an example of the allocation of ATM identifiers in the MDE units 3 and 4. Specifically, it shows an example of the correspondence among virtual path (VP) identifiers in ATM, virtual channel (VC) identifiers in ATM, the destination of the signal and explanations (in this embodiment, the type of signal).

For example, the four identifiers with VC=11-14 correspond to the four ports 1-4, respectively, also corresponding to the four signal processing functional blocks (BB1-BB4), being used in the communication of the User Data user signals (U-Plane). In addition, the two identifiers with VC=15 and 16 correspond to port 6 and correspond to the BTS control functional blocks 32 and 52, being used in the communication of the NBAP and ALCAP control signals (C-Plane). In addition, the one identifier with VC=17 corresponds to port 6 and also corresponds to BTS control functional blocks 32 and 52, being used in the communication of local signals (control signals) for control between BTS units. In addition, the one identifier with VC=18 corresponds to port 7 and also corresponds to inter-BTS, being used in the communication of local signals (control signals) for control between BTS units.

As shown in FIG. 5, the ATM identifiers (VP/NVC) are identified by the data types carried in the cell.

In addition, in this embodiment, changing the ATM identifiers at the Iub interface (Iub point) 11 would affect the system so this cannot be adopted, but as shown in FIG. 6, the ATM identifiers within the MDE units 3 and 4 of the BTS unit 1 and 2 systems can be arbitrarily converted. In this embodiment, an interface among MDE units in the ATM layer is possible using the correspondence as shown in FIG. 6.

Specifically, in the ATM switch functional block 33 of the BTS unit 1 system, regarding downlink signals, in the event that user data allocated to be processed by the signal processing functional blocks 55 and 56 of the BTS unit 2 system is input from the Iub interface functional block 31 via port 5, its ATM identifier is converted to an ATM identifier (VC=18) that is output to the MDE interface functional blocks 43 and 63 via port 7. In addition, in the ATM switch functional block 53 of the BTS unit 2 system, regarding downlink signals, in the event that user data allocated to be processed by the signal processing functional blocks 55 and 56 of the BTS unit 2 system is input from the MDE interface functional block 63 via port 7, its ATM identifier is converted to an ATM identifier (VC=12) that is output to the signal processing functional block 55 via port 2 or to an ATM identifier (VC=13) that is output to the signal processing functional block 56 via port 3.

In addition, in the ATM switch functional block 53 of the BTS unit 2 system, regarding uplink signals, in the event that user data allocated to be processed by the signal processing functional blocks 55 and 56 of the BTS unit 2 system is input from the signal processing functional block 55 via port 2, or input from the signal processing functional block 56 via port 3, its ATM identifier is converted to an ATM identifier (VC=18) that is output to the MDE interface functional blocks 63 and 43 via port 7. In addition, in the ATM switch functional block 33 of the BTS unit 1 system, regarding uplink signals, in the event that user data allocated to be processed by the signal processing functional blocks 55 and 56 of the BTS unit 2 system is input from the MDE interface functional block 43 via port 7, its ATM identifier is converted to an ATM identifier based on the Iub interface (Iub point) 11 (that illustrated in FIG. 5), so that the signal for this user data is output from the Iub interface functional block 31 to the Iub interface 11 via port 5.

In this manner, the format of the ATM identifier consists of VP and VC, so regarding the ATM identifier, the identifier can be freely changed by ATM within the MDE units 3 and 4 and between the MDE units 3 and 4. As an example, the VP can be used as the address number for the various wireless base transceiver station units (various BTS units) while the VC can be used as the address number for the various baseband processing blocks of the wireless base transceiver station units (in this embodiment, the signal processing functional blocks 34-37 and 54-57), thereby specifying the identifier. In this embodiment, one base transceiver station unit may use such an identifier of the destination to which processing is to be passed, to use an ATM switch to pass processing to another base transceiver station unit.

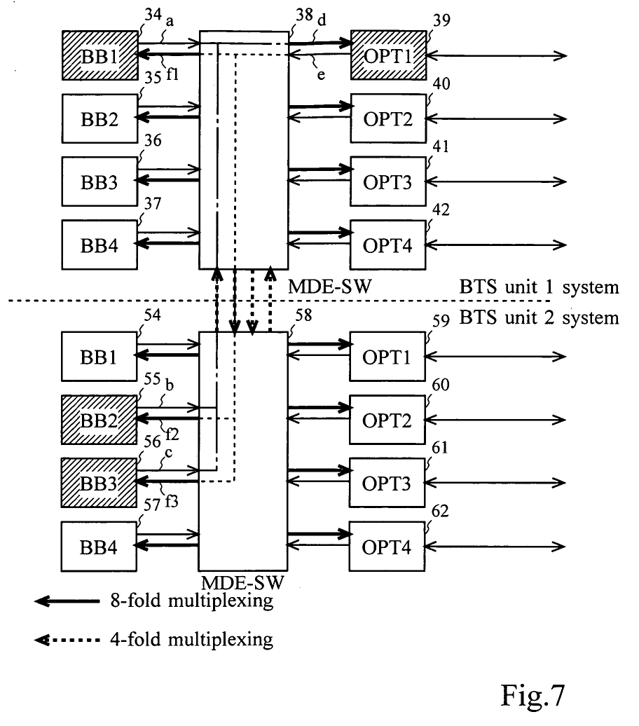

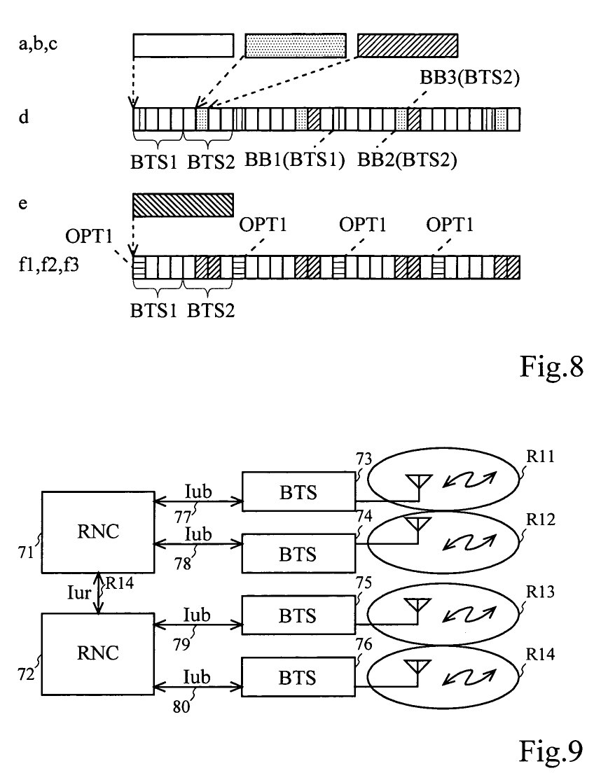

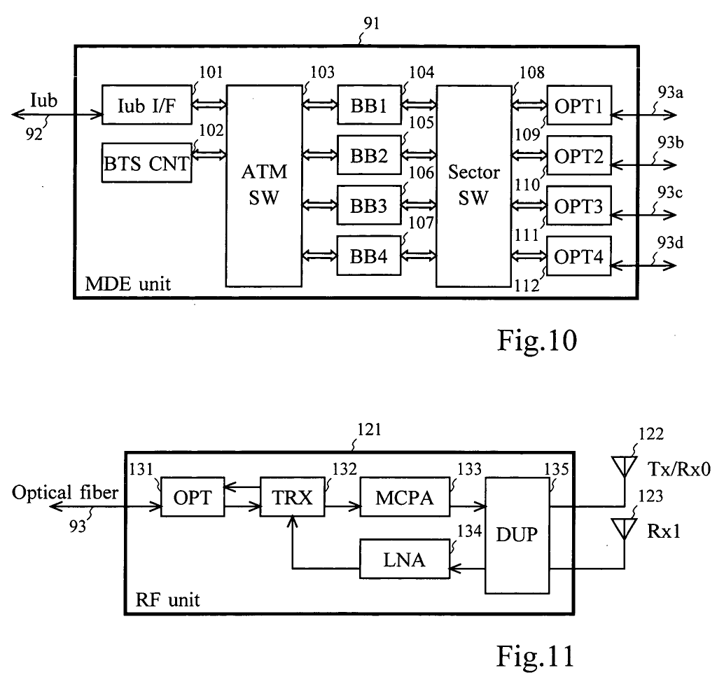

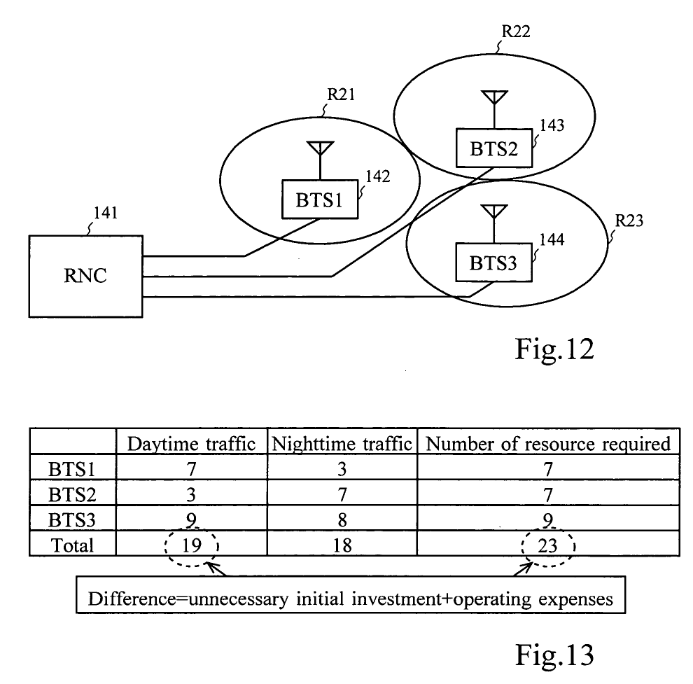

With reference to FIGS. 7 and 8, an example of the operations performed by the MDE sector switch functional blocks 38 and 58 of this embodiment is illustrated.

FIG. 7 illustrates the MDE sector switch functional block 38 of the BTS unit 1 system and the various processing blocks 34-37 and 39-42 connected thereto, along with the MDE sector switch functional block 58 of the BTS unit 2 system and the various processing blocks 54-57 and 59-62 connected thereto. Note that the MDE interface functional blocks 43 and 63 are omitted from the figure.

FIG. 8 shows an example of the appearance of the various signals a, b, c, d, e, f1, f2 and f3 shown in FIG. 7. In the example of FIG. 8, the three downlink signals a, b and c are subjected to time-division multiplexing to form one downlink signal, and one uplink signal e is multiplexed with another uplink signal to form the uplink signals f1, f2 and f3.

For example, in the case that a spread-modulated downlink signal a is output from the signal processing functional block 34 of the BTS unit 1 system, a spread-modulated downlink signal b is output from the signal processing functional block 55 of the BTS unit 2 system, and a spread-modulated downlink signal c is output from the signal processing functional block 56 of the BTS unit 2 system, this signal b and this signal c are transmitted to the MDE sector switch functional block 38 of the BTS unit 1 system via the MDE sector switch functional block 58 of the BTS unit 2 system and then multiplexed together with the signal a in the MDE sector switch functional block 38 of the BTS unit 1 system and transmitted to the optical conversion functional block 39 of the BTS unit 1 system.

In addition, for example, in the case that an uplink signal e is output from the optical conversion functional block 39 of the BTS unit 1 system, this signal e is multiplexed with the other uplink signals in the MDE sector switch functional block 38 of the BTS unit 1 system and these multiplexed signals f1, f2 and f3 are transmitted to the signal processing functional blocks 34-37 of the BTS unit 1 system and the signal processing functional blocks 54-57 of the BTS unit 2 system. Specifically, in this embodiment, signal e from the optical conversion functional block 39 is multiplexed with signals from the other optical conversion functional blocks 40-42 and 59-62, and these multiplexed signals f1, f2 and f3 are transmitted to the signal processing functional blocks 34-37 and 54-57.

In this manner, by means of the MDE sector switch functional blocks 38 and 58, regarding signals in the downlink direction, signals from all of the signal processing functional blocks 34-37 and 54-57 arrive at the optical conversion functional blocks 39-42 and 59-62, and regarding signals in the uplink direction, signals from all of the optical conversion functional blocks 39-42 and 59-62 are distributed to the signal processing functional blocks 34-57. In this case, the signals input and output by the signal processing functional blocks 34-37 and 54-57 and the optical conversion functional blocks 39-42 and 59-62 become an 8-fold multiplexed signal, and the signals that are input/output between the two MDE units 3 and 4 are 4-fold multiplexed signals. Thereby, an interface between the MDE units 3 and 4 is possible with signals on the spread-modulated signal level by means of the MDE sector switch functional blocks 38 and 58.

In addition, in this embodiment, the MDE sector switch functional blocks 38 and 58 perform the process of, regarding downlink signals, transmitting signals processed by the baseband processing blocks (in this embodiment, the signal processing functional blocks 34-37 and 54-57) by time division to the optical conversion functional blocks 39-42 and 59-62, and regarding uplink signals, performing the process of transmitting the signals from all of the optical conversion functional blocks 39-42 and 59-62 to the baseband processing blocks (in this embodiment, the signal processing functional blocks 34-37 and 54-57).

As described above, with the wireless base transceiver station (BTS) according to this embodiment, in a configuration wherein the modulation/demodulation apparatus consisting of MDE units 3-6 and RF units 7-10 is connected by optical fibers 15-18 and perform optical transmission by means of optical transmission apparatus, an interface function (in this embodiment, the MDE interface functional blocks 43 and 63) is provided between the ATM layer within the MDE units 3-6 and the two parts of the spread-modulated signal level and the other MDE units 3-6, and thereby channel resources are shared within a wireless base transceiver station system consisting of a plurality of wireless base transceiver stations.

Specifically, with the wireless base transceiver station according to this embodiment, the MDE units 3-6 of each of the wireless base transceiver stations are disposed centrally at a single location and the RF units 7-10 may be disposed away from the MDE units 3-6 on the side of the service areas R1-R4, for example, and tied to the centrally located MDE units 3-6 by means of an interface function. In addition, the situation of channel resource usage by the various MDE units 3-6 (e.g., the number of channels in use and the number of unused channels) is determined and the info thus determined is exchanged among the MDE units 3-6. Thus, a wireless base transceiver station with insufficient resources issues a request for the allocation of resources to another wireless base transceiver station, and in response another wireless base transceiver station with an excess of resources returns a reply to the effect that the allocation of resources for this request is possible. Thereby, control is exerted so as to open paths by which the sharing of resources among MDE units 3-6 is possible with respect to the ATM switch functional blocks 33 and 53 and the MDE sector switch functional blocks 38 and 58 within the MDE units 3-6.

In addition, the wireless base transceiver stations according to this embodiment have special ports for connecting the MDE units 3-6, and by performing the conversion of ATM identifiers, perform input/output with respect to other MDE units 3-6, and also, in order to avoid the unnecessary collision of cells within the ATM switch functional blocks 33 and 53, the deletion of cells that have impossible ATM identifiers is performed.

In addition, the wireless base transceiver stations according to this embodiment have special ports for connecting the MDE units 3-6, and regarding signals in the downlink direction, multiplex signals from the signal processing functional blocks 34-37 and 54-57 within their own MDE units 3-6 and transmit them via specified optical conversion functional blocks 39-42 and 59-62 to remotely installed RF units 7-10. Regarding signals in the uplink direction, signals from the optical conversion functional blocks 39-42 and 59-62 within their own MDE units 3-6 are multiplexed with signals from the optical conversion functional blocks 39-42 and 59-62 within the other MDE units 3-6, and thus transmitted to the signal processing functional blocks 34-37 and 54-57 of its own and the other MDE units 3-6.

Accordingly, with the wireless base transceiver station according to this embodiment, the sharing of the channel resources of the MDE units 3-6 of the wireless base transceiver stations is achieved, so that the unused resources of other wireless base transceiver stations can be utilized, and thus unused resources of the MDE units 3-6 of the wireless base transceiver stations can be flexibly allocated depending on fluctuations in the traffic in the service areas R1-R4, and thus it is possible to flexibly respond to dynamic changes in traffic depending on the time zone or other factors.

In addition, with the wireless base transceiver station according to this embodiment, from the standpoint of the telecommunications carrier, it is possible to allocate resources within the system so as to follow traffic, and thus it is not necessary to purchase unneeded wireless base transceiver stations, thereby reducing initial facilities expenses. In addition, by centrally locating the MDE units 3-6 of the typically complex wireless base transceiver stations, maintenance work can be simplified and operating expenses can be reduced. By means of the architecture of the mobile telecommunications system according to this embodiment wherein resources within the system can be allocated to follow fluctuations in traffic, it is possible to reduce initial facilities costs and operating costs, so it is effective in the case of implementing a wireless base transceiver station system that involves large-scale resources, for example. As an example, it is possible to construct infrastructure at a much lower cost when the resources are shared among a plurality of wireless base transceiver stations as in this example, in comparison to the case of installing a single wireless base transceiver station that has a huge number of resources.

Here, in this embodiment, a configuration is illustrated wherein, when one wireless base transceiver station uses the unused resources of another wireless base transceiver station, the ATM switches (in this embodiment, the ATM switch functional blocks 33 and 53) and MDE switches (in this embodiment, the MDE sector switch functional blocks 38 and 58) are used to pass the processing to another wireless base transceiver station. However, as examples of other configurations, a configuration wherein two ATM switches are used, or a configuration wherein switches of types different from ATM switches or MDE switches are used may also be used; for example an internet protocol (IP) or other packet switch may also be used.

In addition, this embodiment illustrated a configuration wherein processing is passed among a plurality of wireless base transceiver stations connected to the same radio network controller (RNC) so that one wireless base transceiver station uses the unused resources of another wireless base transceiver station. However, as another example of a configuration, it is possible to use a configuration wherein processing is passed among a plurality of wireless base transceiver stations connected to different radio network controllers (RNC) so that one wireless base transceiver station uses the unused resources of another wireless base transceiver station. Specifically, using FIG. 1 as an example, this example shows a configuration wherein processing is passed among two wireless base transceiver stations (in this embodiment, MDE unit 3 and MDE unit 4) that are connected to the same RNC unit 1, or processing is passed among two wireless base transceiver stations (in this embodiment, MDE unit 5 and MDE unit 6) that are connected to the same RNC unit 2, so that one wireless base transceiver station uses the unused resources of another wireless base transceiver station. However, as another example of a configuration, it is possible for processing to be passed among the wireless base transceiver stations (in this embodiment, MDE unit 3 and MDE unit 4) connected to one RNC unit 1 and the wireless base transceiver stations (in this embodiment, MDE unit 5 and MDE unit 6) connected to the other RNC unit 2, so that one wireless base transceiver station uses the unused resources of another wireless base transceiver station.

Note that in the wireless base transceiver station according to this embodiment, the functions of the signal processing functional blocks 34-37 and 54-57 provided in the MDE units 3 and 4 constitute the communications signal processing means, and the functions of the BTS control functional blocks 32 and 52 provided in the MDE units 3 and 4 constitute the means of allocating communications signal processing to another unit, while the functions of the ATM switch functional blocks 33 and 53, the functions of the MDE sector switch functional blocks 38 and 58 and the functions of the MDE interface functional blocks 43 and 63 provided in the MDE units 3 and 4 constitute the means of communicating communications signals among other units.

In addition, in the wireless base transceiver station according to this embodiment, the functions of the BTS control functional blocks 32 and 52 provided in the MDE units 3 and 4 constitute the other unit communications signal processing excess capacity detection means consisting of the other unit communications signal processing excess capacity inquiry means and the other unit communications signal processing excess capacity response reception means, as well as the one unit communications signal processing excess capacity response transmission means.

In addition, in the wireless base transceiver station according to this embodiment, the functions of the ATM switch functional blocks 33 and 53 and the functions of the MDE sector switch functional blocks 38 and 58 provided in the MDE units 3 and 4 constitute the switching means.

Here, the constitution of the wireless base transceiver station system, wireless base transceiver stations, MDE units, RF units and the like according to the present invention is not necessarily limited to that presented above, but rather various constitutions may be used. Note that the present invention may also be provided as a method of executing the process according to the present invention, or as a computer program for implementing such a method.

In addition, the applicable fields of the present invention are not necessarily limited to those illustrated above, but rather the present invention may be applied to various fields.

In addition, the various processing performed in the wireless communications apparatus or the like according to the present invention may be constituted by being implemented in hardware resources equipped with a processor and memory and the like, for example, being controlled by means of a processor executing a control program stored in read-only memory (ROM). In addition, the various functional means for executing this processing may also be constituted as independent hardware circuits.

In addition, the present invention may also be understood as one wherein the above control program (itself) is stored in a floppy disc®, CD-ROM or other computer-readable recording media, so that the processing according to the present invention can be implemented by loading said control program from the recording medium into a computer and executing the program by a processor.

1. A wireless base transceiver station unit that wirelessly communicates communications signals wherein:
the wireless base transceiver station unit comprises:
a communications signal processing means that processes communications signals,
a means of allocating communications signal processing to another unit that allocates communications signal processing means provided on another wireless base transceiver station unit as the communications signal processing means that processes communications signals from one unit, and
a means of communicating communications signals among other units that communicates communications signals from the one unit to which a communications signal processing means provided on another wireless base transceiver station unit is allocated by the means of allocating communications signal processing to another unit.

2. A wireless base transceiver station unit according to claim 1, wherein:
the means of allocating communications signal processing to another unit allocates a communications signal processing means that has excess communications signal processing capacity which is provided in another wireless base transceiver station unit, as the communications signal processing means to process communications signals from the one unit, and
regarding communications signals from the one unit to which a communications signal processing means provided on another wireless base transceiver station unit is allocated by the means of allocating communications signal processing to another unit, the means of communicating communications signals among other units transmits said communications signal before processing by the communications signal processing means to said other wireless base transceiver station unit, and receives from said other wireless base transceiver station unit said communications signal after processing by the communications signal processing means.

3. A wireless base transceiver station unit according to claim 1, wherein:
the wireless base transceiver station unit comprises:
excess capacity detection means that detects excess communications signal processing capacity in a communications signal processing means which is provided in another wireless base transceiver station unit.

4. A wireless base transceiver station unit according to claim 2, wherein:
the wireless base transceiver station unit comprises:
excess capacity detection means that detects excess communications signal processing capacity in a communications signal processing means which is provided in another wireless base transceiver station unit.

5. A wireless base transceiver station unit according to claim 3, wherein:
the excess capacity detection means comprises:
excess capacity inquiry means that makes inquires to other wireless base transceiver station units about the excess communications signal processing capacity in a communications signal processing means provided in said other wireless base transceiver station unit, and
excess capacity response reception means that receives responses from the other wireless base transceiver station units to inquiries made by the excess capacity inquiry means,
and thus detects the excess communications signal processing capacity situation of the communications signal processing means provided in said other wireless base transceiver station unit based on said response.

6. A wireless base transceiver station unit according to claim 4, wherein:
the excess capacity detection means comprises:
excess capacity inquiry means that makes inquires to other wireless base transceiver station units about the excess communications signal processing capacity in a communications signal processing means provided in said other wireless base transceiver station unit, and
excess capacity response reception means that receives responses from the other wireless base transceiver station units to inquiries made by the excess capacity inquiry means,
and thus detects the excess communications signal processing capacity situation of the communications signal processing means provided in said other wireless base transceiver station unit based on said response.

7. A wireless base transceiver station unit according to claim 1, wherein:
the wireless base transceiver station unit comprises:
excess capacity response transmission means that, in response to an inquiry from another wireless base transceiver station unit, transmits a response about the excess communications signal processing capacity in the communications signal processing means provided on the one unit to said other wireless base transceiver station unit.

8. A wireless base transceiver station unit according to claim 2, wherein:
the wireless base transceiver station unit comprises:
excess capacity response transmission means that, in response to an inquiry from another wireless base transceiver station unit, transmits a response about the excess communications signal processing capacity in the communications signal processing means provided on the one unit to said other wireless base transceiver station unit.

9. A wireless base transceiver station unit according to claim 3, wherein:
excess capacity detection device that detects excess communications signal processing capacity in a communications signal processing means which is provided in a wireless base transceiver station unit is provided externally to the wireless base transceiver station unit, and
the excess capacity detection means of the wireless base transceiver station unit receives from the excess capacity detection device notice of the results of detection of the excess communications signal processing capacity situation of the communications signal processing means provided on other wireless base transceiver station units, and based on this notice, detects the excess communications signal processing capacity situation of the communications signal processing means provided on other wireless base transceiver station units.

10. A wireless base transceiver station unit according to claim 4, wherein:
excess capacity detection device that detects excess communications signal processing capacity in a communications signal processing means which is provided in a wireless base transceiver station unit is provided externally to the wireless base transceiver station unit, and
the excess capacity detection means of the wireless base transceiver station unit receives from the excess capacity detection device notice of the results of detection of the excess communications signal processing capacity situation of the communications signal processing means provided on other wireless base transceiver station units, and based on this notice, detects the excess communications signal processing capacity situation of the communications signal processing means provided on other wireless base transceiver station units.

11. A wireless base transceiver station unit according to claim 1, wherein:
the means of communicating communications signals among other units uses switching to communicate with other wireless base transceiver station units those communications signals from the one unit to which a communications signal processing means provided on another wireless base transceiver station unit is allocated by the means of allocating communications signal processing to another unit.

12. A wireless base transceiver station unit according to claim 2, wherein:
the means of communicating communications signals among other units uses switching to communicate with other wireless base transceiver station units those communications signals from the one unit to which a communications signal processing means provided on another wireless base transceiver station unit is allocated by the means of allocating communications signal processing to another unit.

13. A wireless base transceiver station unit according to claim 11, wherein:
the wireless base transceiver station unit comprises:
switching means that perform switching are provided on both the stage before and the stage after the communications signal processing means, respectively, and
the one wireless base transceiver station unit and the other wireless base transceiver station unit communicate communications signals between mutually corresponding switching means.

14. A wireless base transceiver station unit according to claim 12, wherein:
the wireless base transceiver station unit comprises:
switching means that perform switching are provided on both the stage before and the stage after the communications signal processing means, respectively, and
the one wireless base transceiver station unit and the other wireless base transceiver station unit communicate communications signals between mutually corresponding switching means.

15. A wireless base transceiver station unit according to claim 13, wherein:
the wireless base transceiver station unit comprises:
an MDE unit provided with communications signal processing means and switching means, and a RF unit provided with wireless communications functions, which are connected to constitute a unit.

16. A wireless base transceiver station unit according to claim 14, wherein:
the wireless base transceiver station unit comprises:
an MDE unit provided with communications signal processing means and switching means, and a RF unit provided with wireless communications functions, which are connected to constitute a unit.

17. A wireless base transceiver station unit according to claim 15, wherein:
the wireless base transceiver station unit is such that:
the means of communicating communications signals among other units communicates communications signals from the one unit to which a communications signal processing means provided on another wireless base transceiver station unit is allocated by the means of allocating communications signal processing to another unit, between the MDE unit of the one unit and the MDE unit of the other wireless base transceiver station unit.

18. A wireless base transceiver station unit according to claim 16, wherein:
the wireless base transceiver station unit is such that:
the means of communicating communications signals among other units communicates communications signals from the one unit to which a communications signal processing means provided on another wireless base transceiver station unit is allocated by the means of allocating communications signal processing to another unit, between the MDE unit of the one unit and the MDE unit of the other wireless base transceiver station unit.

19. A wireless base transceiver station unit according to claim 1, wherein:
the wireless base transceiver station unit comprises:
downlink communications signals subject to wireless transmission are transmitted wirelessly after being processed by downlink communications signal processing means provided on the one unit or the other wireless base transceiver station unit, and
uplink communications signals received wirelessly are transmitted to the other unit after being processed by uplink communications signal processing means provided on the one unit or the other wireless base transceiver station unit.

20. A wireless base transceiver station unit according to claim 2, wherein:
the wireless base transceiver station unit comprises:
downlink communications signals subject to wireless transmission are transmitted wirelessly after being processed by downlink communications signal processing means provided on the one unit or the other wireless base transceiver station unit, and
uplink communications signals received wirelessly are transmitted to the other unit after being processed by uplink communications signal processing means provided on the one unit or the other wireless base transceiver station unit.
